(19) United States
(12) Patent Application Publication
(10) Pub. No.: US 2011/0121649 A1
(43) Pub. Date: May 26, 2011

(54) ENERGY SAVINGS BASED ON POWER FACTOR CORRECTION

(75) Inventors: Youssef A. LOLDJ, Sunnyvale, CA (US); Miroslav GELO, San Jose, CA (US); Jay J. JUNG, Sunnyvale, CA (US); Daniel O. CLARK, Pleasanton, CA (US)

(73) Assignee: APPLIED MATERIALS, INC., Santa Clara, CA (US)

(21) Appl. No.: 12/946,337

(22) Filed: Nov. 15, 2010

Related U.S. Application Data
(60) Provisional application No. 61/261,718, filed on Nov. 16, 2009.

(51) Int. Cl. H02J 3/18; H02J 3/00

(52) U.S. Cl. 307/31; 307/39

(57) ABSTRACT

Methods and apparatus for enhanced control over electronic device manufacturing systems are provided herein. In some embodiments, an integrated sub-fab system in accordance with the present invention may be provided with fixed or real time power factor management, correction, reporting, and tabulation. Such a system could also be used by any industry consuming significant levels of power. The integrated sub-fab system power management could be extended to other parts of the factory where high levels of power are used.

### CROSS-REFERENCE TO RELATED APPLICATIONS

This application claims benefit of U.S. provisional patent application Ser. No. 61/261,718, filed Nov. 16, 2009, which is herein incorporated by reference

### FIELD

The present invention is related to the manufacture of electronic devices, and more specifically, to systems and methods for increasing the efficiency for electronic device manufacturing systems.

### BACKGROUND

Electronic device manufacturing facilities or “fabs”, typically employ process tools which perform manufacturing processes in the production of electronic devices. A fab is typically laid out with a clean room on one floor, and a room containing auxiliary systems and devices which support the clean room on a lower floor, also referred to as a “sub-fab.” Vacuum pumps and other Variable Frequency Drive (VFD) and inductive motor driven equipment, inductive heaters, and high power blowers used in sub-fab and fab operations result in poor power factor (PF). Without PF correction, power users consume more energy than necessary and produce bad power factor, leading to harmonics that increase the risk of failure or faulty operation of other equipment.

This invention implements power factor correction to reduce power consumption and reports PF correction energy savings.

### SUMMARY

Methods and apparatus for enhanced control over electronic device manufacturing systems are provided herein. In some embodiments, an integrated sub-fab system in accordance with the present invention may be provided with fixed or real time power factor management, correction, reporting, and tabulation. Such a system could also be used by any industry consuming significant levels of power. The integrated sub-fab system power management could be extended to other parts of the factory where high levels of power are used.

In some embodiments, an integrated sub-fab system may include a plurality of sub-fab auxiliary systems and/or devices; a sub-fab front end controller coupled to the sub-fab front end controller to control the operation of the plurality of sub-fab auxiliary systems and/or devices; and a line reactor coupled to one or more of the plurality of sub-fab auxiliary systems and/or devices to provide power factor correction for the one or more of the plurality of sub-fab auxiliary systems and/or devices.

In some embodiments, an integrated sub-fab system may include a plurality of sub-fab auxiliary systems and/or devices; a sub-fab front end controller coupled to the sub-fab front end controller to control the operation of the plurality of sub-fab auxiliary systems and/or devices; and a switch disposed in line with one or more of the plurality of sub-fab auxiliary systems and/or devices, wherein the sub-fab front end controller controls the switch to selectively disconnect the one or more of the plurality of sub-fab auxiliary systems and/or devices from power when the one or more of the plurality of sub-fab auxiliary systems and/or devices are not required.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a schematic depiction of a system for operating an electronic device manufacturing system sub-fab in accordance with some embodiments of the present invention.

FIG. 2 is a schematic depiction of an integrated sub-fab system for use in an electronic device manufacturing system in accordance with some embodiments of the present invention.

FIGS. 3-4 depict graphs of exemplary energy savings obtained from power factor correction of a pump in accordance with some embodiments of the present invention.

FIGS. 5-6 depict schematic diagrams of portions of an integrated sub-fab system having power factor correction in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention relate to energy savings, tabulation, and reporting, based on real time or pre-set power factor (PF) correction and harmonic distortion management. In some embodiments, an integrated sub-fab controller is provided that can monitor and maintain the power factor in the system as well as keep track and report trend data for the power factor of the system. An additional benefit of fixed or real time power factor correction is improved equipment reliability due reduced heat generated in each piece of equipment with use of proper power factor and reduced harmonic distortion that can damage electronic components.

Embodiments of the present invention provide improved control systems for a sub-fab that may advantageously reduce the energy usage and operational cost of electronic device manufacturing systems. The sub-fab may contain such auxiliary devices as abatement tools, AC power distributors, primary vacuum pumps, spare vacuum pumps, water pumps, chillers, heat exchangers, inductive heaters and lamps, air handling blowers, electrical power supplies, or the like. The use of this equipment causes sub-fabs to commonly utilize large amounts of energy and other resources, require more maintenance, and produce large amounts of waste heat causing a detrimental environmental effect. All of this may be very expensive for a fab operator.

An example of an electronic device manufacturing system having an integrated sub-fab suitable for modification and use as described herein is provided in commonly owned U.S. patent application Ser. No. 12/365,894, filed Feb. 4, 2009 by Daniel O. Clark, et al., and entitled, “Methods and Apparatus for Operating an Electronic Device Manufacturing System,” and which is herein incorporated by reference in its entirety.

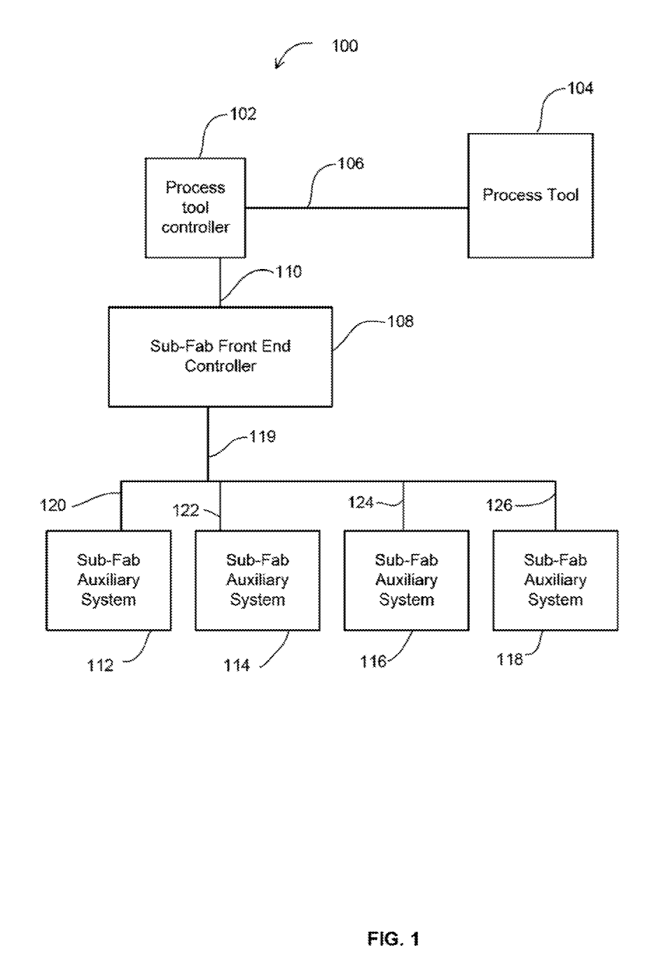

FIG. 1 is a schematic depiction of a system 100 for operating an electronic device manufacturing system sub-fab in accordance with some embodiments of the present invention. System 100 may include a process tool controller 102 which may be linked to a process tool 104 through communication link 106. Process tool controller 102 may be any microcomputer, microprocessor, logic circuit, a combination of hardware and software, or the like, suitable to control the operation of the process tool 104. For example, process tool controller 102 may be a PC, server tower, single board computer, and/or a compact PCI, etc. Process tool 104 may be any electronic device manufacturing process tool which requires effluent abatement and/or other resources from a sub-fab support system.

The process tool controller 102 may be linked to the sub-fab front end controller 108 by means of communication link 110. The sub-fab front end controller 108 may be any microcomputer, microprocessor, logic circuit, a combination of hardware and software, or the like, suitable to control the sub-fab auxiliary systems/device 104. For example, sub-fab front end controller 108 may be a PC, server tower, single board computer, and/or a compact PCI, etc.

The sub-fab front end controller 108 may in turn be linked to sub-fab auxiliary systems/devices 112, 114, 116 and 118 through communication links 120, 122, 124 and 126, respectively. The Sub-fab auxiliary systems/devices may each have a controller (not shown), such as a PLC. Alternatively, the sub-fab front end controller 108 may perform the functionality of a lower-level PLC controller for any or all of the sub-fab auxiliary systems/devices. Although four sub-fab auxiliary systems/devices are shown, it should be noted that more or fewer than four sub-fab auxiliary systems/devices may be linked to the sub-fab front end controller 108. The sub-fab auxiliary devices may include, but are not limited to, abatement tools, AC power distributors, primary vacuum pumps, spare vacuum pumps, water pumps, chillers, heat exchangers, inductive heaters and lamps, air handling blowers, electrical power supplies, or the like.

In operation, process tool controller 102 may control process tool 104 by operating one or more of robots, doors, pumps, valves, plasma generators, power supplies, etc. As described above, process tool controller 102 may be constantly aware regarding the state of, and resource requirements of, each chamber in the process tool 104 and of the process tool 104 as a whole. The process tool controller 102 may communicate such resource requirements to the sub-fab front end controller 108 which may in turn control one or more sub-fab auxiliary systems/devices 112, 114, 116 and 118 by operating pumps, switches valves, power supplies, and/or other hardware through communication links 119, 120, 122, 124 and 126. In this fashion, the amount of energy which may be required to operate the sub-fab equipment may be reduced to a level which provides sufficient resources to safely and efficiently operate the process tool 104 and to fully abate the effluent which flows from the process tool 104.

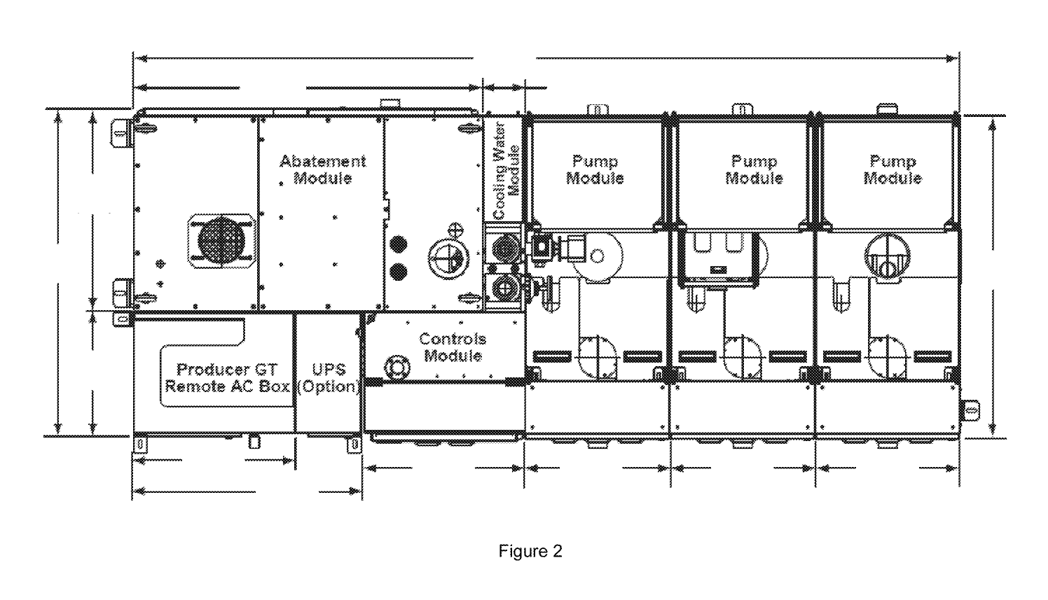

In some embodiments, the integrated sub-fab system communicates with an “open platform” equipment set to provide a lower carbon footprint operation of a process tool for a production application. For example, FIG. 2 depicts one non-limiting configuration of such a system showing a compact, integrated system having an abatement module, a cooling water module, pump modules, a remote AC power box, an uninterruptable power supply (UPS), and a controls module. The open platform advantageously accommodates customer equipment preferences and achieves lowest environmental footprint, best technical performance, highest throughput, and lowest cost of ownership. For example, such a configurable sub-fab system may include one or more abatement units, vacuum pumps, chillers, interconnections for various systems, and utilities distribution in a compact unit synchronized with one or more process tools via an integrated sub-fab controller (such as sub-fab front end controller 108, discussed above). In addition, the energy control system as described herein may also be utilized in existing or new facilities with dispersed components (e.g., not compactly configured as in FIG. 2).

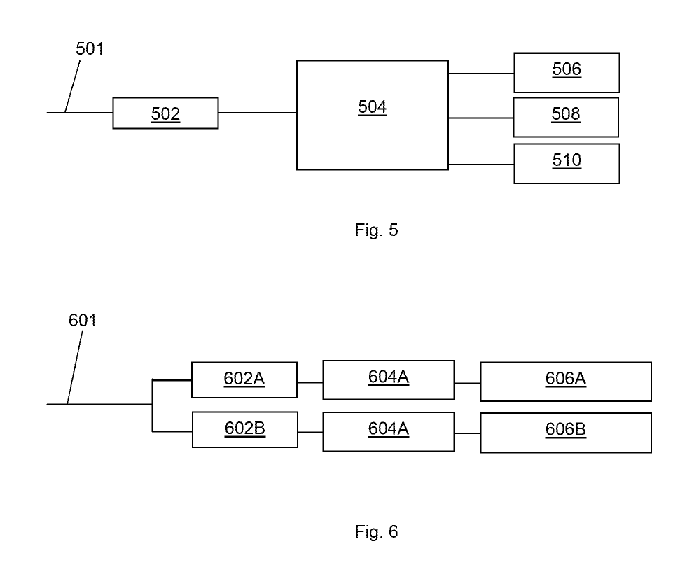

The integrated sub-fab system can implement power factor correction methods and systems for the integrated sub fab equipment including vacuum pumps, chillers, water circulation pumps, air blowers, and the like. The power factor correction can be passive or active (e.g., fixed or real-time). To reduce overall energy usage, the integrated sub-fab system implements several variable frequency drives and rectifiers in the system. The speed reduction afforded by use of this equipment is a great benefit and allows the optimization of the system based on real process tool usage. However, the rectifiers may have a negative effect of introducing distortions in the current drawn from the system. In such cases, inductive loads such as line reactors can be implemented to counteract the distortion and raise and improve the power factor. The line reactors can be implemented for vacuum pumps in different locations as described in FIGS. 5-6 below.

For example, embodiments of the present invention may utilize line reactors to correct the power factor for variable frequency drives used to control high energy consuming motors. Additionally, any equipment that consumes high energy and imparts either an inductive or capacitive component to the circuit, such as blowers and capacitive plasma power supplies, are examples of equipment that benefit from fixed or real time power factor correction. For some sets of equipment, a fixed line reactor may be sufficient. For example, in some embodiments, a line reactor can be inserted in the power line feeding particular equipment, or a set of equipment, such as a vacuum pump. FIG. 5 depicts a schematic diagram of a portion of an integrated sub-fab system having power factor correction in accordance with some embodiments of the present invention. As shown in FIG. 5, a line reactor 502 may be placed in a power line 501 leading to a power distributor 504. The power distributor 504 may distribute power to one or more pieces of equipment (e.g., 506, 508, 510). For example, in some embodiments, the power distributor 504 may be a power distribution for a set of dry and booster pumps disposed in the sub fab. In embodiments where a singular piece of equipment is being used, the power distributor may be omitted and the line reactor 502 may be coupled to the equipment without the use of the power distributor 504.

In addition, rather than providing a line reactor in line with a power distributor for a set of equipment, in some embodiments, dedicated line reactors can be inserted in the power line right before the VFD or rectifier for particular equipment, such as a booster pump, a dry pump, or the like. For example, FIG. 6 depicts a schematic diagram of a portion of an integrated sub-fab system having power factor correction in accordance with some embodiments of the present invention. As shown in FIG. 6, a first line reactor 602A may be placed in a power line 601 leading to a VFD or rectifier 604A of a first equipment 606A (e.g., a first pump, such as a booster pump). A second line reactor 602B may be placed in the power line 601 leading to a VFD or rectifier 604B of a second equipment 606B (e.g., a second pump, such as a dry pump). Additional line reactors may be provided for variable frequency drives or rectifiers of additional equipment.

For equipment sets where various inductive or capacitive loads can be substituted into the platform tool set, a real time tunable power factor correction can be applied at the tool or platform level of factory facilitization. By providing point of use fixed or variable factor correction at the tool or platform level, the factory does not have to implement more expensive and larger power factor correction line reactors at each factory module or across the entire factory, which would require changing out the large line reactor every time a new set of equipment is added or a platform configuration is changed. For example, In some embodiments, the integrated sub-fab system might also include a dynamic power factor correction unit. The dynamic power factor correction unit may include a bank of capacitors or inductors, these devices will be included in the power circuit by contactors or solid state relays as needed to maintain a power factor as close as possible to 1. The switching of these capacitors and inductors can be controlled by the sub-fab controller based on feedback obtained by a regulator that measures and reports the power factor in the electrical network (e.g., a power factor meter).

In the case of inductive loads such as motors, the sub-fab integrated system can also include network of capacitors to improve the power factor and reduce the apparent power. For inductive motors, the integrated sub-fab system can use fixed or real time capacitive PF correction. Capacitive PF correction can be implemented via a solid state or mechanical means switching capacitors into and out of the circuit. The key components of a typical capacitor bank include: (1) A Power Factor Correction (PFC) controller. The PFC includes a microprocessor that analyzes the signal from a current transformer and produces switching commands to control the contactors that add or remove capacitor stages. Intelligent control by the PFC controller ensures an even utilization of capacitor steps, minimized number of switching operations and optimized life cycle; (2) Fuse/MCCB—an HRC fuse or MCCB acts as a safety device for short circuit protection; (3) Capacitor contactor—contactors are electromechanical switching elements used to switch capacitors or reactors and capacitors in standard or detuned PFC systems. The switching operation can be performed by mechanical contacts or an electronic switch (semiconductor). The latter solution is preferable if fast switching is required for a sensitive load for example; (4) Reactor. (compensation and filtering)—power distribution networks are increasingly subjected to harmonic pollution from modern power electronic devices, so called nonlinear loads, e.g., drives, uninterruptible power supplies, electronic ballasts. Harmonics are dangerous for capacitors connected in the PFC circuit, especially if the capacitors operate at resonant frequency. The series connection of reactor and capacitor to detune the series resonant frequency (the capacitor's resonant frequency) helps to prevent capacitor damage. Critical frequencies are the 5th and 7th harmonics (250 and 350 Hz). Detuned capacitor banks also decrease the harmonic distortion level and clean the network; and (5) Capacitor—power factor correction capacitors produce the necessary leading reactive power to compensate the lagging reactive power. PFC capacitors should be capable of withstanding high inrush currents caused by switching operations (>100*IN). If capacitors are connected in parallel, i.e., as banks, the inrush current will increase (>150*IN) because the charging current comes from the grid as well as from capacitors parallel to the switched one.

For variable frequency drive (VFD) control of pump motors, the issue is capacitive variance in the power factor, so integrated sub-fab system can alternately utilize inductive line reactors to afford fixed or real time inductive PF and reduce line harmonics (noise). For both capacitive and inductive PF correction, the integrated sub-fab system may have the ability to reduce or filter harmonic distortion to improve ancillary equipment lifetime and reliability. For example, the introduction of a power factor correction can be used to minimize harmonic distortion. In addition, harmonic filters may be provided to remove or reduce harmonic distortion caused by use of power with improper power factor. POU power factor correction reduces the cost and the overall apparent energy for the factory while improving equipment reliability. Poor power factor and high power system harmonic distortion damages electronic equipment greatly shortening the lifetime of components.

In some embodiments, both cumulative and real time PF savings for each point of use (POU) tool set may be tabulated by monitoring the power for line harmonics and inductive or capacitive shifts in the power factor by use of a power factor meter and/or a harmonic analyzer that report to a controller, such as the sub-fab controller or some other remote controller, storage, or display. For example, in addition to providing fixed or real time power factor correction, embodiments of this invention may include the reporting of energy savings and the power factor correction being implemented. Thus, the integrated sub-fab system may further allow the factory owner to read real time the actual power factor energy savings in addition to the entire energy savings for each tool set within the factory. In some embodiments, a power factor meter may be provided to read and report real time power factor and/or line harmonic distortion to the sub-fab controller to enable remote or local real time or accumulative power factor correction, harmonic distortion, and energy savings. Further the ability to tabulate PF energy savings data within the integrated sub-fab system allows automatic reporting of the PF energy saved on that tool set over time. Reports could be granular to the sub set level or cover the entire tool set. All systems that the integrated sub-fab system monitors within the factory can be reported individually or in preferred groupings to monitor specific power savings.

Idling inductive motors used for pumps and compressors and keeping them on line causes significant deleterious harmonics and power factor shifts. The integrated sub-fab system can disconnect inductive loads at the POU when they are not needed, for example, by controlling a switch to connect or disconnect the inductive load as desired. This capability additionally reduces the impact of harmonics and PF which waste energy and decrease component reliability. Implementing PF correction point of use also saves costs as wire gauges do not have to be as large for high current circuits. Implementing PF correction at POU tool set is more cost effective, energy and cost saving, and precise than trying to implement a single power factor correction at the factory connection.

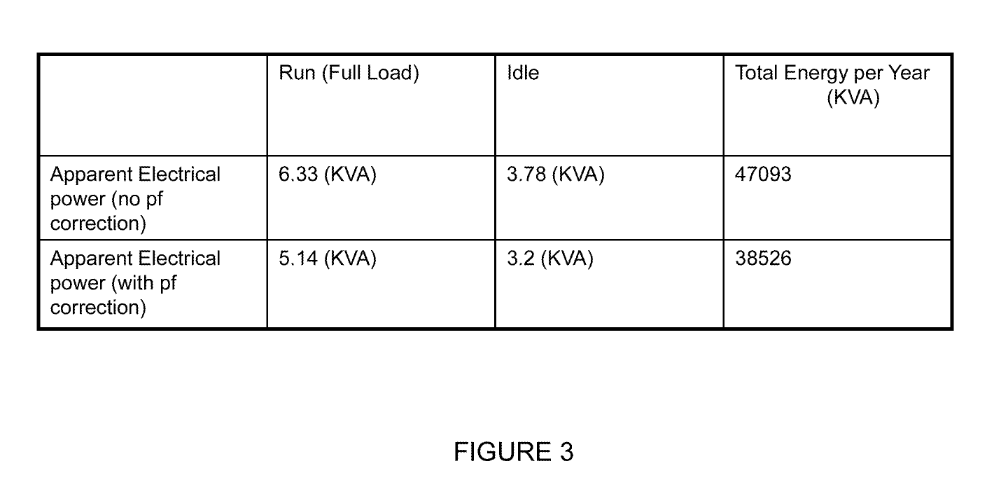

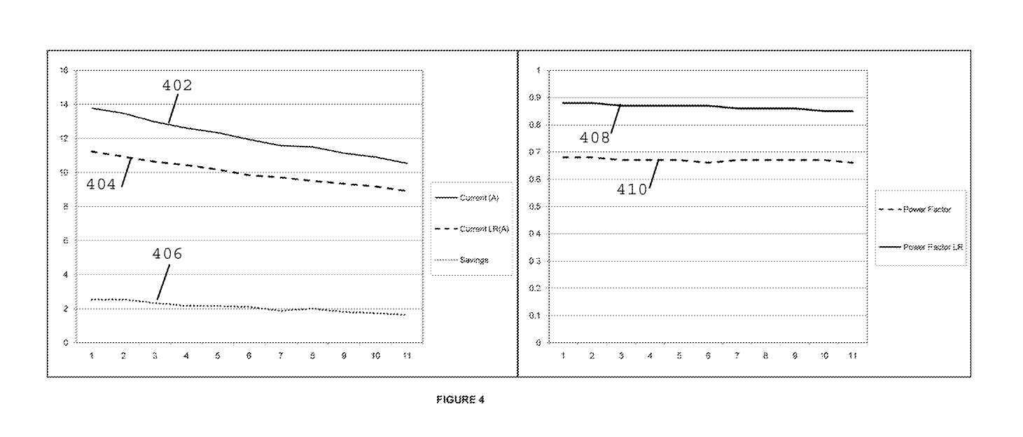

For example, FIGS. 3-4 depict examples showing energy consumption with and without PF correction as tested by the inventors. FIG. 3 shows estimated energy savings for a pump (specifically, an Ebarra EST 200W) with PF correction in accordance with embodiments of the present invention. Energy savings were achieved by adding a line reactor in the power line in accordance with the present invention and correcting the power factor from about 0.67 to about 0.87. In the table of FIG. 3, the annual energy use is calculated based on 70% run time, 25% idle time, and 5% off. As can be seen from the table, a total energy savings per year of 8,567 KVA or an about 18% reduction was provided by the present invention.

FIG. 4 depicts graphs of power correction and savings of a vacuum pump in accordance with some embodiments of the present invention. As depicted in FIG. 4, current without power factor correction is shown by line 402 and current with a line reactor (e.g., with power factor correction) is shown by line 404. The difference between the two, the savings obtained by power factor correction, is graphed as line 406. For the same equipment, the original power factor is graphed as line 410 with the corrected power factor graphed as line 408. It is readily apparent how providing a line reactor for a given piece of sub-fab equipment can improve the power factor and reduce energy consumption within the sub-fab. The reduced energy consumption can be multiplied use of the present invention to correct the power factor of numerous pieces of sub-fab equipment in one or more equipment or tool sets throughout the factory.

Examples of PF correction and control provided by the integrated sub-fab system may include, but are not limited to, one or more of the following: inductive PF correction for VFD motors and capacitive PF correction for inductive motors; cumulative reporting of PF savings per tool set; real time reporting of PF savings; ability to take tools off line when in idle, sleep or hibernate non-production modes of operation as to not send harmonic reflections back into the distribution network; real time or pre-set PF correction options; many reporting options; power management could be extended to other parts of the factory, air and water cooling, implant, lamp tools, water production and delivery, air handling for house scrubber and clean room blowers, and the like.

Some benefits of PF correction may include one or more of the following: reducing the reactive power in a system resulting in a drop in power consumption and a proportionate drop in power costs; a more economical electrical installation; improved voltage quality; fewer voltage drops; optimum cable dimensioning; and smaller transmission losses. The inventive system as described herein could also be used by any industry consuming significant levels of power. The integrated sub-fab system power management could be extended to other parts of the factory, air and/or water cooling, implant, lamp tools, water production and delivery, air handling for house scrubber and clean room blowers, and the like.

While the foregoing is directed to embodiments of the present invention, other and further embodiments of the invention may be devised without departing from the basic scope thereof.

1. An integrated sub-fab system, comprising:
a plurality of sub-fab auxiliary systems and/or devices;
a sub-fab front end controller coupled to the sub-fab front end controller to control the operation of the plurality of sub-fab auxiliary systems and/or devices; and
a line reactor coupled to one or more of the plurality of sub-fab auxiliary systems and/or devices to provide power factor correction for the one or more of the plurality of sub-fab auxiliary systems and/or devices.

2. The system of claim 1, wherein the plurality of sub-fab auxiliary systems and/or devices comprise one or more of abatement tools, AC power distributors, primary vacuum pumps, spare vacuum pumps, water pumps, chillers, heat exchangers, inductive heaters and lamps, air handling blowers, or electrical power supplies.

3. The system of claim 1, further comprising a harmonic filter coupled one or more of the plurality of sub-fab auxiliary systems and/or devices to provide harmonic distortion reduction.

4. The system of claim 1, further comprising:
a harmonic analyzer to provide line harmonic distortion data to the sub-fab front end controller.

5. The system of claim 1, further comprising:
a plurality of line reactors respectively coupled to a corresponding plurality of the plurality of sub-fab auxiliary systems and/or devices to provide power factor correction for the corresponding plurality of the plurality of sub-fab auxiliary systems and/or devices.

6. The system of claim 5, wherein the plurality of sub-fab auxiliary systems and/or devices are disposed within a point of use tool platform such that the integrated sub-fab system reduces energy consumption at the platform level.

7. The system of claim 1, wherein the line reactor is an active line reactor and further comprising:
a power meter to provide data corresponding to power factor to the sub-fab front end controller.

8. The system of claim 7, wherein the sub-fab front end controller collects data corresponding to energy savings due to power correction based at least in part from data provided by the power meter.

9. The system of claim 8, wherein the data corresponding to energy savings includes real time or accumulative power factor correction, harmonic distortion, and energy savings.

10. The system of claim 8, wherein the sub-fab front end controller tabulates power factor energy savings data within the integrated sub-fab system and reports power factor energy savings on a desired tool set.

11. The system of claim 7, wherein the sub-fab front end controller collects data corresponding to energy savings, power factor correction, harmonic reduction, and energy consumption.

12. The system of claim 7, wherein the data corresponding to energy savings, power factor correction, harmonic reduction, and energy consumption are tabulated and reported by the sub-fab front end controller.

13. The system of claim 1, further comprising:
a switch disposed in line with one or more of the plurality of sub-fab auxiliary systems and/or devices, wherein the sub-fab front end controller controls the switch to selectively disconnect the one or more of the plurality of sub-fab auxiliary systems and/or devices from power when the one or more of the plurality of sub-fab auxiliary systems and/or devices are not required.

14. An integrated sub-fab system, comprising:
a plurality of sub-fab auxiliary systems and/or devices;
a sub-fab front end controller coupled to the sub-fab front end controller to control the operation of the plurality of sub-fab auxiliary systems and/or devices; and
a switch disposed in line with one or more of the plurality of sub-fab auxiliary systems and/or devices, wherein the sub-fab front end controller controls the switch to selectively disconnect the one or more of the plurality of sub-fab auxiliary systems and/or devices from power when the one or more of the plurality of sub-fab auxiliary systems and/or devices are not required.

15. The system of claim 14, wherein the plurality of sub-fab auxiliary systems and/or devices comprise one or more of abatement tools, AC power distributors, primary vacuum pumps, spare vacuum pumps, water pumps, chillers, heat exchangers, inductive heaters and lamps, air handling blowers, or electrical power supplies.
